(19) United States
(12) Patent Application Publication
(10) Pub. No.: US 2025/0208353 A1
(43) Pub. Date: Jun. 26, 2025

(54) POLARIZATION ROTATION BEAM SPLITTER USABLE WITH LITHIUM CONTAINING OPTICAL DEVICES AND DUAL POLARIZATION IQ MODULATION

(71) Applicant: HyperLight Corporation, Cambridge, MA (US)

(72) Inventors: Yu Zhang, Cambridge, MA (US); Christian Reimer, Wellesley, MA (US)

(21) Appl. No.: 18/988,597

(22) Filed: Dec. 19, 2024

Related U.S. Application Data
(60) Provisional application No. 63/613,695, filed on Dec. 21, 2023.

(51) Int. Cl. G02B 6/27

(52) U.S. Cl. CPC G02B 6/2773; G02B 6/2766

(57) ABSTRACT

A polarization rotation splitter/combiner (PRBS) is described. The PRBS includes a waveguide, a combiner, and a polarization rotator. The waveguide includes a first channel and a second channel. The combiner is configured to combine a first beam for the first channel and a second beam for the second channel to a combined output having combined mode. The polarization rotator is coupled with the combiner and is configured to rotate a first polarization of the combined output corresponding to a first combined mode and to rotate a second polarization of the combined output corresponding to a second combined mode. The polarization rotator providing an output having orthogonal output modes. Thus, both of the orthogonal output modes are rotated greater than zero degrees and less than ninety degrees relative to the combined modes.

### CROSS REFERENCE TO OTHER APPLICATIONS

This application claims priority to U.S. Provisional Patent Application No. 63/613,695 entitled POLARIZATION ROTATION BEAM SPLITTER FOR LITHIUM CONTAINING OPTICAL DEVICES USABLE WITH DUAL POLARIZATION IQ filed Dec. 21, 2023 which is incorporated herein by reference for all purposes.

### BACKGROUND OF THE INVENTION

Polarization rotation beam splitter/combiners (PRBSes) may be useful in optical communications. For example, a PRBS may be used in connection with dual polarization in-phase and quadrature IQ (DPIQ) modulators. A PRBS may operate in a splitting mode (e.g., receiving light from one port and outputting light to two ports) or a combing mode, in which the optical signals travel in the opposite direction (e.g. receiving light from two ports and outputting light to one port). In the combining mode, the PRBS receives optical signals (e.g., light) from two ports. For example, a first optical fiber may input a first optical signal to a first arm (or channel) of a waveguide, while a second optical fiber may input a second optical signal to a second arm (or channel) of the waveguide. Each of the input optical signals typically includes TE modes only. The optical signals may be processed and combined such that two modes are present in a single waveguide. To combine the optical signals, a y-splitter/combiner might be used. For example, the combined optical signal may include a first mode from the optical signal in the first channel and a second mode from the second optical signal in the second channel. The first mode is a TE0 mode, while the second optical mode is a TE1 mode. These modes have their polarizations horizontal (e.g. parallel to a surface of the device). Thus, the optical signal traveling in the waveguide after the combiner includes only TE0 and TE1 modes.

A typical polarization rotator used in a PRBS rotates the polarization of the TE1 mode, while leaving the TE0 mode unchanged. Thus, the (horizontally polarized) TE1 mode may be converted to a (vertically polarized) TM0 mode. The output of the PRBS has orthogonal modes: a TE0 and a TM0 mode. Stated differently, the PRBS rotates only one of the two modes such that the output of the PRBS is two modes having orthogonal polarization.

Although the PRBS functions, one of ordinary skill in the art will recognize that there are drawbacks. In order to achieve the desired TE0 and TE1 modes, the combiner (e.g., a y-splitter/combiner) is engineered with tight tolerances. Small changes in the y-splitter/combiner may adversely affect the modes supported. For example, small alterations to the splitting ratio between the waveguide arms or the gap between the arms at the base of the splitter change the modes supported. Thus, fabrication of the PRBS may be challenging. Accordingly, what is needed is an improved PRBS.

### BRIEF DESCRIPTION OF THE DRAWINGS

Various embodiments of the invention are disclosed in the following detailed description and the accompanying drawings.

FIGS. 1A-1D depict an embodiment of a polarization rotation beam splitter/combiner and the change in polarization of the output polarization.

FIGS. 2A-2C depict an embodiment of a polarization rotation beam splitter/combiner and the change in polarization of the output polarization.

FIG. 3 is a flow chart depicting a method for using a polarization rotation beam splitter/combiner.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Polarization rotation beam splitter/combiners (PRBSes) typically combine TE modes to provide a TE0 and a TE1 mode to be input to a polarization rotator. The polarization rotator rotates the polarization of the TE1 mode, while leaving the polarization of the TE0 mode unchanged. Thus, the (horizontally polarized) TE1 mode may be converted to a (vertically polarized) TM0 mode. In contrast, the polarization of the (horizontally polarized) TE0 mode remains unchanged. The output of the PRBS has orthogonal modes: a TE0 and a TM0 mode. The TM0 and TE0 modes also improve wafer level testing. For example, gratings that are used to collect light for testing typically only collect TE or only TM. Thus, testing of operation of the PRBS may also be simplified. However, fabrication is challenging. For example, the splitting ratio and gap for the y-splitter/combiner are tightly controlled to ensure the presence of TE0 and TE1 modes entering the polarization rotator. Consequently, improvements are desired.

A polarization rotation splitter/combiner is described. The PRBS includes a waveguide, a combiner, and a polarization rotator. The waveguide includes a first channel and a second channel. The combiner is configured to combine a first beam for the first channel and a second beam for the second channel to a combined output having a combined mode. The polarization rotator is coupled with the combiner and is configured to rotate a first polarization of the combined output corresponding to a first combined mode and to rotate a second polarization of the combined output corresponding to a second combined mode. The polarization rotator providing an output having orthogonal output modes. Thus, both of the orthogonal output modes are rotated greater than zero degrees and less than ninety degrees relative to the combined modes.

In some embodiments, the combined modes are also orthogonal. In some embodiments, the polarizations of the orthogonal output modes are not horizontal and not vertical with respect to a top surface of the polarization rotation beam splitter/combiner. In some embodiments, the combiner has an arbitrary splitting ratio. In some such embodiments, the combiner has a splitting ratio such that the first polarization and the second polarization each include TE0 and TE1 modes. In some embodiments, the orthogonal output modes have a first output polarization of P1=a1*TE0+b1*TE1 and a second output polarization of P2=a2*TE0−b2*TE1, where a1, b1, a2, and b2 are each nonzero, where TE0 is a TE0 mode, and where TE1 is TE1 mode. In some embodiments, the polarization rotator provides the output to free space or an optical fiber. The polarization of each mode of the orthogonal output modes may be at least three degrees from parallel to a top surface of the polarization rotator and at least three degrees from perpendicular to the top surface of the polarization rotator. In some embodiments, the polarization of a combined mode of the combined modes is at least three degrees from parallel to a surface of the polarization rotation beam splitter/combiner and at least three degrees from perpendicular to the surface of the polarization rotation beam splitter/combiner. In some embodiments, the combined modes and the orthogonal output modes are each elliptically polarized. In some embodiments, the first polarization is at least eighty-three and not more than ninety-three degrees from the second polarization. The orthogonal output modes may be polarized within three degrees of perpendicular.

A polarization rotation beam splitter/combiner including a waveguide, a combiner, and a polarization rotator is described. The waveguide includes first and second channels. The combiner is configured to combine a first beam for the first channel and a second beam for the second channel to provide a combined output including combined orthogonal modes. The polarization rotator is coupled with the combiner. The polarization rotator is also configured to rotate a first polarization of the combined orthogonal modes corresponding to the first beam and to rotate a second polarization of the combined orthogonal modes corresponding to the second beam. The polarization rotator has orthogonal output modes. Both the first polarization and the second polarization are rotated by greater than zero degrees and less than ninety degrees. Both the first polarization and the second polarization are not horizontal and not vertical with respect to a top surface of the polarization rotation beam splitter/combiner.

A method is disclosed. The method includes providing optical signals to a waveguide including a first channel and a second channel. The waveguide provides the optical signals to a combiner that combines a first beam for the first channel and a second beam for the second channel to a combined output having combined modes that may be orthogonal. The combiner is coupled to a polarization rotator such that the combined output is provided to the polarization rotator. The polarization rotator rotates a first polarization of the combined output corresponding to a first combined mode and rotates a second polarization of the combined output corresponding to a second combined mode. The polarization rotator provides an output having orthogonal output modes. Both of the orthogonal output modes are rotated greater than zero degrees and less than ninety degrees relative to the combined modes.

A method is disclosed. The method includes providing optical signals to a waveguide including a first channel and a second channel. The waveguide provides the optical signals to a combiner that combines a first beam for the first channel and a second beam for the second channel to a combined output having combined modes that may be orthogonal. The combiner is coupled to a polarization rotator such that the combined output is provided to the polarization rotator. The polarization rotator rotates a first polarization of the combined output corresponding to a first combined mode and rotates a second polarization of the combined output corresponding to a second combined mode. The polarization rotator provides an output having orthogonal output modes. Both of the orthogonal output modes are rotated greater than zero degrees and less than ninety degrees relative to the combined modes.

In some embodiments, polarizations of the orthogonal output modes are not horizontal and not vertical with respect to a top surface of the polarization rotator. The combiner may have an arbitrary splitting ratio. In some embodiments, the orthogonal output modes have a first output polarization of P1=a1*TE0+b1*TE1 and a second output polarization of P2=a2*TE0−b2*TE1, where a1, b1, a2, and b2 are each nonzero, where TE0 is a TE0 mode, and where TE1 is TE1 mode. The combined modes and the orthogonal output modes may each be elliptically polarized. In some embodiments, the method includes testing the polarization states of the modes output by the polarization rotator.

Various features of the optical devices are described herein. One or more of these features may be combined in manners not explicitly described herein. In addition, only portions of the optical devices are shown. Further, although an input is indicated in the drawings and/or described in the text, in some embodiments, signals may be reversed such that the input functions as an output.

The optical devices described herein may be formed using electro-optic materials, such as thin film lithium containing (TFLC) electro-optical materials. For example, thin film lithium niobate (TFLN) and/or thin film lithium tantalate (TFLT) may be used for the components described. Although primarily described in the context of TFLC electro-optic materials, such as TFLN and TFLT, other nonlinear optical materials may be used in the optical devices described herein. For example, other ferroelectric nonlinear (e.g. second order) optical materials may also be desired to be used in, e.g., waveguide 141. Such ferroelectric nonlinear optical materials may include but are not limited to potassium niobate (e.g. KNbO₃), gallium arsenide (GaAs), potassium titanyl phosphate (KTP), lead zirconate titanate (PZT), and barium titanate (BaTiO₃). The techniques described may also be used for other nonlinear ferroelectric optical materials, particularly those which may otherwise be challenging to fabricate. For example, such nonlinear ferroelectric optical materials may have inert chemical etching reactions using conventional etching chemicals such as fluorine, chlorine or bromine compounds.

In some embodiments, the optical material(s) used are nonlinear. As used herein, a nonlinear optical material exhibits the electro-optic effect and has an effect that is at least (e.g. greater than or equal to) 5 picometer/volt. In some embodiments, the nonlinear optical material has an effect that is at least 10 picometer/volt. In some such embodiments nonlinear optical material has an effect of at least 20 picometer/volt. The nonlinear optical material experiences a change in index of refraction in response to an applied electric field. In some embodiments, the nonlinear optical material is ferroelectric. In some embodiments, the electro-optic material effect includes a change in index of refraction in an applied electric field due to the Pockels effect. Thus, in some embodiments, optical materials possessing the electro-optic effect in one or more the ranges described herein are considered nonlinear optical materials regardless of whether the effect is linearly or nonlinearly dependent on the applied electric field. The nonlinear optical material may be a non-centrosymmetric material. Therefore, the nonlinear optical material may be piezoelectric. Such nonlinear optical materials may have inert chemical etching reactions for conventional etching using chemicals such as fluorine, chlorine or bromine compounds. In some embodiments, the nonlinear optical material(s) include one or more of LN, LT, potassium niobate, gallium arsenide, potassium titanyl phosphate, lead zirconate titanate, and barium titanate. In other embodiments, other nonlinear optical materials having analogous optical characteristics may be used.

In some embodiments, waveguides described herein, such as waveguide 141, are low optical loss waveguides. For example, a waveguide may have a total optical loss of not more than 10 dB through the portion of waveguide (e.g. when biased at maximum transmission and as a maximum loss) in proximity to electrodes used in modulating the optical signal. The total optical loss is the optical loss in a waveguide through a single continuous electrode region (e.g. as opposed to multiple devices cascaded together). In some embodiments, the waveguide has a total optical loss of not more than 8 dB. In some embodiments, the total optical loss is not more than 4 dB. In some embodiments, the total optical loss is less than 3 dB. In some embodiments, the total optical loss is less than 2 dB. In some embodiments, the waveguide has an optical loss of not more than 3 dB/cm (e.g. on average). In some embodiments, the nonlinear material(s) in the waveguides has an optical loss of not more than 2.0 dB/cm. In some such embodiments, the waveguide has an optical loss of not more than 1.0 dB/cm. In some embodiments, the waveguide has an optical loss of not more than 0.5 dB/cm. In some embodiments, the low optical losses are associated with a low surface roughness of the side walls of the waveguides.

The waveguides may have improved surface roughness. For example, the short range root mean square surface roughness of a sidewall of the ridge may be less than ten nanometers. In some embodiments, this root mean square surface roughness is not more than five nanometers. In some cases, the short range root mean square surface roughness does not exceed two nanometers. In some embodiments, a waveguide includes a ridge portion and a slab portion. The height of such a ridge portion is selected to provide a confinement of the optical mode such that there is a 10 dB reduction in intensity from the intensity at the center of the ridge at ten micrometers from the center of the ridge. For example, the height of the ridge is on the order of a few hundred nanometers in some cases. However, other heights are possible in other embodiments. Various other optical components may be incorporated into the waveguide to provide the desired functionality. For example, the waveguide may have wider portion(s) for accommodating multiple modes or performing other functions.

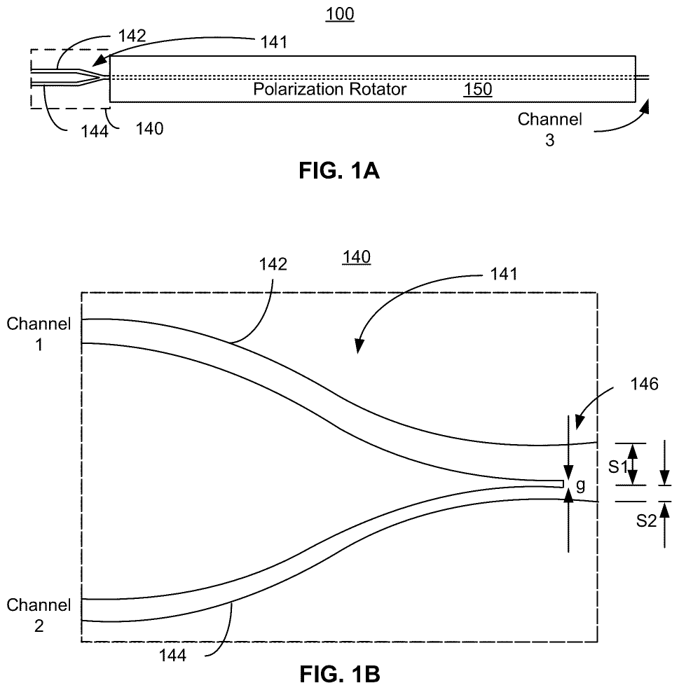

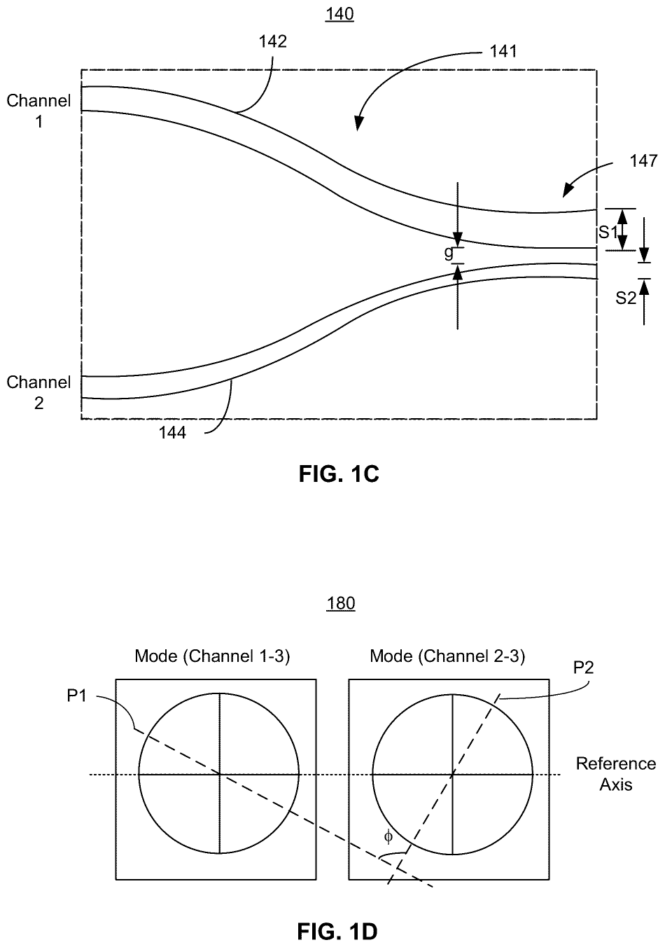

FIGS. 1A-1D depict an embodiment of polarization rotation beam splitter/combiner (PRBS) 100 and the change in polarization of the output polarization. FIG. 1A is a high-level diagram of PRBS 100. FIG. 1B is a detailed view of one embodiment of combiner 140. FIG. 1C is a detailed view of another embodiment of combiner 140. FIG. 1D is a diagram 180 indicating the change in polarization and the output polarizations from the input channels. For clarity, only certain features are shown. In addition, a particular configuration (e.g. a gap, spitting ratio, etc.) is shown. However, other configurations are possible. FIGS. 1A-1D are not to scale.

PRBS 100 includes combiner 140 and polarization rotator 150 that operate on optical signals carried by waveguide 141. Waveguide 141 may include or consist of electro-optic materials such as TFLC material(s). Waveguide 141 includes arms 142 and y-splitter/combiner 146. Although combiner 140 and polarization rotator 150 are described as being separate components from waveguide 141, combiner 140 and polarization rotator 150 may be formed by configuring (e.g., the height, width, taper, junctions, etc.) of waveguide 141. PRBS 100 may operate in a combining mode (optical signals input via channel 1 and channel 2 and output via channel 3) or in a splitter mode (optical signals input via channel 3 and output via channel 1 and channel 2). For clarity, PRBS 100 is described in the context of operating as a combiner.

Optical signals (e.g., light beams) are input to PRBS 100 via channel 1 in waveguide arm 142 and channel 2 in waveguide arm 144. In some embodiments, the optical signals input to PRBS 100 include TE modes only. For example, the optical signal in channel 1/waveguide arm 142 may include a mix of TE0 and TE1 modes. The optical signal in channel 2/waveguide arm 144 may include a mix of TE0 and TE1 modes that is the same or different from that in waveguide arm 142. In some embodiments, each waveguide arm 142 and waveguide arm 144 may include only a TE0 mode. The optical signals input to the first and second channels may, for example, be elliptically polarized, left or right handed circularly polarized, linearly polarized at a nonzero and non-right angle from the surface of combiner 140 (i.e. the top surface of waveguide 141). In some embodiments, the polarizations of the optical signals input to channels 1 and 2 are not orthogonal. In other embodiments, the polarizations of the optical signals input to channels 1 and 2 are orthogonal.

FIGS. 1B and 1C depict two embodiments of combiner 150. Referring to FIG. 1B, the optical signals from waveguide arms 142 and 144 are combined at y-splitter/combiner 146. Y-splitter/combiner 146 has a gap, g, between waveguide arms 142 and 144 and a splitting ratio S1/S2, based on the geometry of y-splitter/combiner 146. In some embodiments, y-splitter/combiner 146 is symmetric. For such a y-splitter/combiner 146 S1/S2=1, which corresponds to a 50:50 power split between the optical modes from waveguide arm 142 and the optical modes from waveguide arm 144. However, an arbitrary splitting ratio may be used. For example, the splitting between waveguide arms 142 and 144 may be from 10:90 through 90:10. In some embodiments, the splitting between waveguide arms 142 and 144 is from 25:75 through 75:25. Thus, the splitting ratio for y-splitter/combiner 146 may be tailored to the application for which PRBS 100 is to be used. In some embodiments, the gap g is not more than one micrometer. In some embodiments, the gap is not more than five hundred nanometers. In some embodiments, the gap is not more than two hundred and fifty nanometers. In some embodiments, the gap is at least ten nanometers.

Referring to FIG. 1C, another embodiment combiner 140 is shown. Combiner 140 includes directional coupler 147 with waveguides 142 and 144 (corresponding to waveguide arms 142 and 144 of FIG. 1B) having two different widths, S1 and S2. In some embodiments, one wide waveguide (e.g. waveguide 142) supports TE0 and TE1 modes more. The second waveguide width (S2 of waveguide 144) is configured such that the optical indices of the TE1 mode in the wide waveguide and the waveguide mode in the second waveguide are similar to facilitate coupling. Directional coupler 147 outputs a combined signal analogous to the combined signal from y-splitter/combiner 146. Thus, combiner 140 may use y-splitter/combiner 146, directional coupler 147, or another type of combiner. For simplicity, the embodiments herein are described in the context of y-splitter/combiner 146. However, other types of combiners may be used.

Y-splitter/combiner 146 combines the optical signals from waveguide arms 142 and 144. This optical signal (“combined optical signal”) is a combination of the optical signals input from channels 1 and 2 and is provided to polarization rotator 150. The combined optical signal includes combined modes (i.e. one combined mode from channel 1 and another combined mode from 2). As used herein, a combined mode indicates that the optical signal has been combined. For example, a first combined mode may correspond to the first optical signal input via waveguide arm 142 after passing through the y-splitter/combiner 146. The second combined mode may correspond to the second optical signal input via waveguide arm 144 after passing through the y-splitter/combiner 146. Each of the combined modes need not be purely TE0 or purely TE1. Instead, a combination of modes may be present for each signal. For example, the combined modes may be elliptically polarized, left or right handed circularly polarized, linearly polarized at a nonzero and non-right angle from the surface of combiner 140 (i.e. the top surface of waveguide 141). The first combined mode of the combined modes may have polarization TE0+TE1. The second combined mode may be TE0−TE1. The first and second combined modes (corresponding to channels 1 and 2, respectively) input to polarization rotator 150 by splitter/combiner 140 are not limited to a purely TM mode and a purely TE mode. Instead, the first and second modes may each be a combination of TE0 and TE1. In some embodiments, other and/or additional higher order modes may be present. In some embodiments, the polarization each of the modes (e.g. TE0+TE1 and TE0−TE1) is at least three degrees from parallel to horizontal (e.g. a top surface of the polarization rotation beam splitter/combiner 100) and/or at least three degrees from perpendicular to horizontal. In some embodiments, the polarization each of the modes (e.g. TE0+TE1 and TE0−TE1) is at least five degrees from parallel to horizontal and/or at least five degrees from perpendicular to horizontal. In some embodiments, the polarizations of the combined modes are orthogonal. In other embodiments, the polarizations of the combined modes are not orthogonal.

Polarization rotator 150 rotates the polarizations of both combined modes input from combiner 140. The output modes from polarization rotator 150 are provided as an output optical signal on a portion of waveguide 141 corresponding to channel 3. Further, the polarizations of the output modes of the output optical signal output by polarization rotator 150 are orthogonal. In some embodiments, the polarizations the output modes of the output optical signal are at an angle at least eighty-five degrees and not more than ninety-five degrees. In some embodiments, the polarizations the output modes are at an angle at least eighty-seven degrees and not more than ninety-seven degrees. In some embodiments, the output modes are at an angle of eight-eight degrees through ninety-two degrees or angles of eighty-nine through ninety-one degrees. As used herein, orthogonal indicates angles of eighty-five through ninety five degrees, angles of eighty seven through ninety-three degrees, eighty-eight through ninety-two degrees, and/or angles of eighty-nine through ninety-one degrees. Thus, the polarizations of the output modes have not only each been rotated greater than zero degrees and less than ninety degrees relative to the combined modes provided from combiner 140 but are also orthogonal

The relationship between the polarizations of the output modes may be seen in FIG. 1C, which includes graph 180 indicating the polarizations of the output modes for some embodiments of PRBS 100. P1 may be considered the output polarization of a first output mode from the first optical signal, which enters from channel 1/waveguide arm 142 and exits PRBS 100 via channel 3. Similarly, P2 may be considered the output polarization of a second output mode from the second optical signal, which enters via channel 2/waveguide arm 144 and exits PRBS 100 via channel 3. P1 and P2 have each been rotated by polarization rotator 150. Further, as indicated by the angle ϕ, P1 and P2 are orthogonal. The first output polarization of the first output mode, P1, may be represented by: P1=a1*TE0+b1*TE1. The second output polarization of the second output mode, P2, may be given by P2=a2*TE0−b2*TE1. For these representations of P1 and P2, a1, b1, a2, and b2 are each nonzero, TE0 is a TE0 mode, and TE1 is TE1 mode. Thus, P1 and P2 are neither parallel nor perpendicular to horizontal (e.g., the top surface of waveguide 141). In other words, P1 and P2 may each be at least five degrees from parallel to the top surface of polarization rotator 150 and at least five degrees from perpendicular to the top surface of polarization rotator 150. In some embodiments, P1 and P2 may each be at least three degrees from parallel to the top surface of polarization rotator 150 and at least three degrees from perpendicular to the top surface of polarization rotator 150.

PRBS 100 may have improved performance and manufacturability. Optical signals that may have TE polarization (e.g. some combination of TE0, TE1, etc.) enter through waveguide arms 142 and 144. These optical signals are combined by y-splitter 146 having a splitting ratio and gap that are not required to ensure that only a TE0 mode for one optical signal and a TE1 mode for another optical signal remain. The combined optical signal is provided to polarization rotator 150 that rotates the polarizations of both combined modes and provides an output signal having orthogonal modes that are each not purely TE0 and TM0. PRBS 100 thus provides orthogonally polarized output modes. However, these orthogonally polarized output modes may be circularly, elliptically, or linearly polarized (not purely perpendicular or parallel to horizontal as described herein). For example, PRBS 100 may be considered to allow for input optical signals that are circularly, elliptically, or linearly polarized and to output modes that are not only circularly, elliptically, or linearly polarized, but that are also rotated from the input polarizations and polarized orthogonally to each other. When functioning as a splitter, PRBS 100 operates in an analogous manner. Thus, PRBS 100 has a versatile design such that PRBS 100 keeps the two polarization states orthogonal while rotating the two polarization states. The two polarization states do not have to be pure TE (horizontal) or TM (vertical). As a result, PRBS 100 may output optical signals having the desired polarizations for the particular application with which PRBS 100 is used. For example, PRBS 100 may be used in conjunction with DPIQ modulators. In such an application, PRBS 100 may receive the output of DPIQ (the two optical signals having TE polarizations) and rotate the polarizations of the two optical signals so that the two polarization states of the output signal are orthogonal.

It has been determined that applications, such as DPIQ modulation, which may use PRBS 100 may not require purely TE0 and TM0 modes for operation. Instead, the TE0 and TM0 modes of a PRBS (including conventional PRBSes which provide purely TE0 and TM0 modes) are generally mixed by optical fibers coupled to the PRBS. Consequently, PRBS 100 having polarizations P1=a1*TE0+b1*TE1 and P2=a2*TE0−b2*TE1 may not adversely affect performance of other the system in which PRBS 100 is used. Because PRBS 100 need not output purely TE0 and TM0 modes, combiner 140 need not output modes that are purely TE0 and TE1. Purely TE0 and TE1 modes require particular configurations of the gap and splitting ratio of a combiner. These configurations have stringent requirements for design and fabrication. Stated differently, traditionally, dimensions are carefully tuned to keep output polarization horizontal and vertical. For example, the y-splitter/combiner gap may be 0.2-0.4 micrometers and the splitting ratio may be 20% to 40% only for such a conventional PRBS. In some cases, these ranges may be challenging to fabricate because the fab generally adds bias to the waveguide width. Thus, the final splitting ratio and gap after fab (i.e. in the device as fabricated) may be different than the designed splitting ratio. Performance of such a PRBS may suffer.

In contrast, the gap and splitting ratio of combiner 140 need not be specifically configured for such pure modes. Thus, other splitting ratios, other gaps, and/or looser tolerances may be used. In some embodiments, the splitting ratio may be between 10 percent though ninety percent for each arm. The gap for PRBS 100 may be less than 0.2 micrometers and/or greater than 0.4 micrometers. Further, in various embodiments, the polarization extinction (splitting) better than 25 dB, better than 30 dB, and/or better than 35 dB. Even if designed with the gaps and splitting ratios in the same ranges as a conventional PRBS, looser tolerances might be used for PRBS 100. Design and manufacturing of PRBS 100 may thus be simplified and yield may be increased. Performance of PRBS 100 may also be improved.

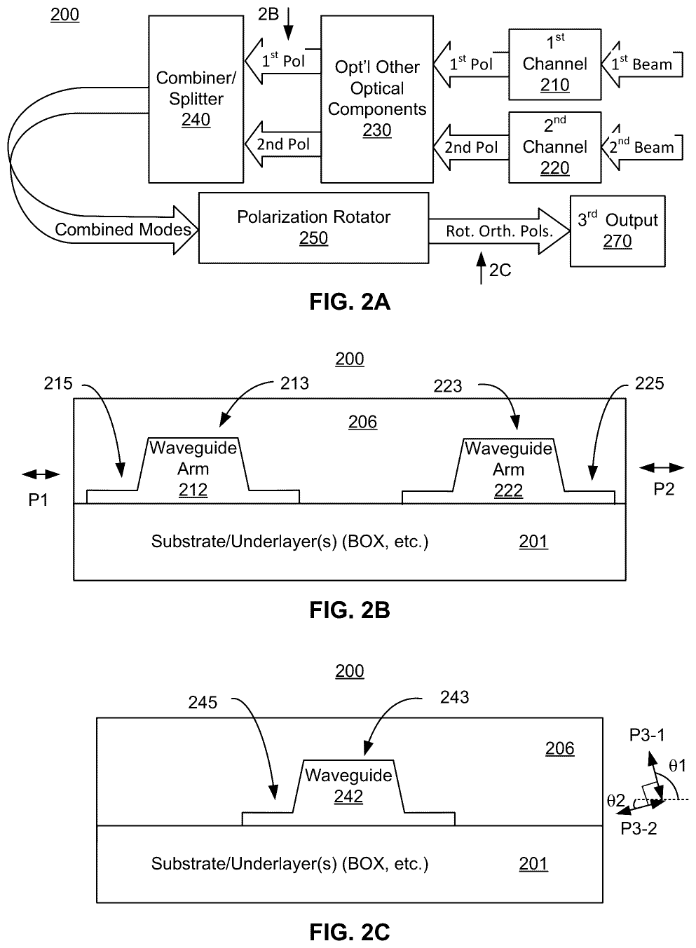

FIGS. 2A-2C depict an embodiment of a polarization rotation beam splitter/combiner 200 and the change in polarization of the output polarization. FIG. 2A is a high-level block diagram of PRBS 200, including components that might be used in conjunction with PRBS 200. FIG. 2B is a cross-sectional view taken at region 2B indicated in FIG. 2A. FIG. 2C is a cross-sectional view taken at region 2C indicated in FIG. 2A. For clarity, only certain features are shown. FIGS. 2A-2C are not to scale. Further, although a bend is shown in FIG. 2A, such a bend may be omitted and/or other bends may be present in other sections of PRBS 200. For clarity, PRBS 200 is described in the context of operating as a combiner. However, PRBS 200 may operate as a splitter for optical signal(s) provided in the opposite path. Although various components of PRBS 200 are described as being separate from the waveguide, such components may be formed by configuring (e.g., the height, width, taper, junctions, etc.) of the waveguide. PRBS 200 is analogous to PRBS 100.

PRBS 200 includes first channel 210 and second channel 220. At 210, a first optical signal (first beam) may be provided to PRBS 200. Similarly, at 220, a second optical signal (second beam) may be provided to PRBS 200. For example, for a DPIQ application an optical signal may be provided to a photonics integrated circuit via one or more input facet(s) (not shown), split into two, sent to two functional devices (not shown), and then provided to PRBS 200 via channels 210 and 220. Thus, channels 210 and 220 may not be separate components, but may simply include the waveguides (e.g. waveguide arms 212 and 222) carrying the optical signals for PRBS 200. The first optical signal input for first channel 210 has a first polarization, while the second optical signal for second channel 220 has a second polarization. In some embodiments, the first and second polarizations are the same, i.e., TE0. Channels 210 and 220 may correspond to arms 212 and 222, respectively of a waveguide depicted in FIG. 2B. The waveguide may include or consist of TFLC optical material(s) such as TFLN and/or TFLT. The first and second optical signals may be provided to other optical components 230. For example, taper(s), mode converter(s), modulator(s) and/or other components may be provided in one or both arms 212 and 222 of the waveguide. Alternatively, some or all of such components may be omitted. The first and second optical signals are then provided to combiner/splitter 240.

FIG. 2B depicts a cross-sectional view of PRBS 200 after optical components 230 and before combiner/splitter 240. Thus, two waveguide arms 212 and 222 carry first and second optical signals, respectively. In the embodiment shown, waveguide arm 212 includes a ridge portion 213 and a thin film, or slab, portion 215. Similarly, waveguide arm 222 includes a ridge portion 223 and a thin film, or slab, portion 225. Polarizations P1 and P2 that may correspond to the first and second optical signals are also shown. In the embodiment shown, polarizations P1 and P2 are horizontal. Polarizations P1 and P2 may be considered to be circular, elliptical, or linear polarizations.

Combiner/splitter 240 is analogous to combiner 140. Thus, combiner/splitter combines waveguide arms 212 and 222 at a y-splitter/combiner (not explicitly shown), a direction coupler, or other mechanism for combining optical signals. Combiner/splitter 240 thus combines the first and second optical signals to provide a combined optical signal having combined modes. A first optical mode corresponds to the first optical signal in waveguide arm 212, while a second optical mode corresponds to the second optical signal in waveguide arm 222. These combined modes include both TE0 and TE1 components, but may differ. Each of the combined modes may be circularly, elliptically, or linearly polarized analogous to those described for PRBS 100.

Combiner/splitter 240 provides the combined optical signal to polarization rotator 250. Polarization rotator 250 rotates the polarizations in an analogous manner to polarization rotator 150. For example, polarization rotator 250 rotates the polarizations of both combined modes and provides an output signal having orthogonal modes that are each not purely TE0 and TM0. FIG. 2C depicts a cross-sectional view of PRBS 200 after polarization rotator 250. Thus, waveguide 242 carries the rotated output modes. Waveguide 242 includes ridge 243 and thin or slab portion 245. Waveguide 242 may include or consist of TFLC materials. The output polarizations P3-1 and P3-2 are shown. The first output mode having polarization P3-1 corresponds to waveguide arm 212. The second output mode having polarization P3-2 corresponds to waveguide arm 222. Polarizations P3-1 and P3-2 have been rotated by angles θ1 and θ2, respectively. Furthermore, polarizations P3-1 and P3-2 are orthogonal (e.g. at an angle of eighty-five through ninety-five degrees or eighty-seven through ninety-seven degrees). The orthogonal, rotated output modes may be output from PRBS 200 via third output 270.

PRBS 200 may share the benefits of PRBS 100. In particular, PRBS 200 may have improved performance, design, and manufacturability. PRBS 200 may be considered to allow for input optical signals that are circularly, elliptically, or linearly polarized and to output modes that are not only circularly, elliptically, or linearly polarized, but that are also rotated from the input polarizations and polarized orthogonally to each other. When functioning as a splitter, PRBS 200 operates in an analogous manner. As a result, PRBS 200 may output optical signals having the desired polarizations for the particular application with which PRBS 200 is used. Moreover, because looser design criteria and/or tolerances may be used in manufacturing PRBS 200, the fabrication of, yield for, and performance of PRBS 200 may be improved.

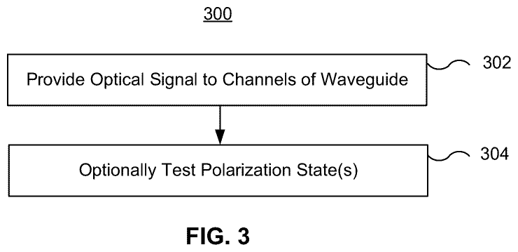

FIG. 3 is a flow chart depicting method 300 for using a PRBS, such as PRBS 100, 200, and/or another analogous PRBS. Method 300 is described in the context of processes that may have sub-processes. Although described in a particular order, another order not inconsistent with the description herein may be utilized. Further, although described in the combining optical signals, method 300 may be extended to splitting of optical signals. Method 300 is also described in the context of PRBS 100. However, method 300 may be used with analogous PRBSes including but not limited to PRBS 200.

Optical signal are provided to waveguide arms, at 302. In some embodiments, the optical signals correspond to different channels carried by each arm of the waveguide. The optical signals traverse the PRBS. Thus, the signals are combined and the combined. The polarizations of both combined modes are rotated, and the resulting output modes are orthogonal.

At 304, the output signals may optionally be tested. Because the output modes are not purely TE0 or purely TM0, the output modes may be tapped from the fiber to which the output optical signal is provided. Thus, testing may occur after coupling with the output fiber instead of at the wafer level.

For example, at 302, optical signals are input to channel 1 (waveguide arm 142) and channel 2 (waveguide arm 144). In some embodiments, this may be accomplished through a fiber/facet interface or by providing optical signals from other component(s) for the photonic integrated circuit to PRBS 100. These optical signals may each be linearly, circularly, or elliptically polarized. The optical signal propagates through waveguide 141 and is combined by y-splitter/combiner 146 or directional coupler 147. The combined modes are provided to polarization rotator. These combined modes are not purely TE0 and TE1. For example, the modes may be a mix of TE0 and TE1 (e.g., TE0+TE1 and TE0−TE1). Polarization rotator 150 rotates the polarizations of both combined modes. Via channel 3, polarization rotator 150 provides an output optical signal having orthogonal polarization modes that are both rotated with respect to the polarizations of the input optical signals. The rotated optical signal may be output from PRBS 100, for example to an optical fiber. For example, this may be accomplished through a fiber/facet interface analogous to facet/fiber 270 and/or 370.

At 304, the output optical signal provided over the fiber may be tested. For example, the polarization states might be determined. Thus, operation of PRBS 100 may still be tested at 304.

Using method 300, the benefits of a PRBS such as PRBS 100, and/or PRBS 200 may be achieved. For example, the PRBS having improved performance, design, and manufacturability may be used.

Although the foregoing embodiments have been described in some detail for purposes of clarity of understanding, the invention is not limited to the details provided. There are many alternative ways of implementing the invention. The disclosed embodiments are illustrative and not restrictive.

1. A polarization rotation splitter/combiner, comprising:
a waveguide including a first channel and a second channel;
a combiner configured to combine a first beam for the first channel and a second beam for the second channel to a combined output having combined modes; and
a polarization rotator, coupled with the combiner, that is configured to rotate a first polarization of the combined output corresponding to a first combined mode and to rotate a second polarization of the combined output corresponding to a second combined mode, the polarization rotator providing an output having orthogonal output modes;
wherein both of the orthogonal output modes are rotated greater than zero degrees and less than ninety degrees relative to the combined modes.

2. The polarization rotation beam splitter/combiner of claim 1, wherein the combined modes are orthogonal.

3. The polarization rotation beam splitter/combiner of claim 1, wherein polarizations of the orthogonal output modes are not horizontal and not vertical with respect to a top surface of the polarization rotation beam splitter/combiner.

4. The polarization rotation beam splitter/combiner of claim 1, wherein the combiner has an arbitrary splitting ratio.

5. The polarization rotation beam splitter/combiner of claim 4, wherein the combiner has a splitting ratio such that the first polarization and the second polarization each include TE0 and TE1 modes.

6. The polarization rotation beam splitter/combiner of claim 1, wherein the orthogonal output modes have a first output polarization of P1=a1*TE0+b1*TE1 and a second output polarization of P2=a2*TE0−b2*TE1, where a1, b1, a2, and b2 are each nonzero, where TE0 is a TE0 mode, and where TE1 is TE1 mode.

7. The polarization rotation beam splitter/combiner of claim 1, wherein the polarization rotator provides the output to free space or an optical fiber.

8. The polarization rotation beam splitter/combiner of claim 1, wherein a polarization of each mode of the orthogonal output modes is at least three degrees from parallel to a top surface of the polarization rotator and at least three degrees from perpendicular to the top surface of the polarization rotator.

9. The polarization rotation beam splitter/combiner of claim 1, wherein the polarization of a combined mode of the combined modes is at least three degrees from parallel to a surface of the polarization rotation beam splitter/combiner and at least three degrees from perpendicular to the surface of the polarization rotation beam splitter/combiner.

10. The polarization rotation beam splitter/combiner of claim 1, wherein the combined modes and the orthogonal output modes are each elliptically polarized.

11. The polarization rotation beam splitter/combiner of claim 1, wherein the first polarization is at least eighty-seven and not more than ninety-three degrees from the second polarization.

12. The polarization rotation beam splitter/combiner of claim 1, wherein the orthogonal output modes are polarized within three degrees of perpendicular.

13. A polarization rotation beam splitter/combiner, comprising:
a waveguide including a first channel and a second channel;
a combiner configured to combine a first beam for the first channel and a second beam for the second channel to provide a combined output including combined orthogonal modes; and
a polarization rotator, coupled with the combiner, configured to rotate a first polarization of the combined orthogonal modes corresponding to the first beam and to rotate a second polarization of the combined orthogonal modes corresponding to the second beam, the polarization rotator having orthogonal output modes;
wherein both the first polarization and the second polarization are rotated by greater than zero degrees and less than ninety degrees; and
wherein both the first polarization and the second polarization are not horizontal and not vertical with respect to a top surface of the polarization rotation beam splitter/combiner.

14. A method, comprising:
providing optical signals to a waveguide including a first channel and a second channel, the waveguide providing the optical signals to a combiner that combines a first beam for the first channel and a second beam for the second channel to a combined output having combined modes that are orthogonal, the combiner being coupled to a polarization rotator such that the combined output is provided to the polarization rotator, the polarization rotator rotating a first polarization of the combined output corresponding to a first combined mode and rotating a second polarization of the combined output corresponding to a second combined mode, the polarization rotator providing an output having orthogonal output modes;
wherein both of the orthogonal output modes are rotated greater than zero degrees and less than ninety degrees relative to the combined modes.

15. The method of claim 14, wherein polarizations of the orthogonal output modes are not horizontal and not vertical with respect to a top surface of the polarization rotator.

16. The method of claim 14, wherein the combiner has an arbitrary splitting ratio.

17. The method of claim 14, wherein the orthogonal output modes have a first output polarization of P1=a1*TE0+b1*TE1 and a second output polarization of P2=a2*TE0−b2*TE1, where a1, b1, a2, and b2 are each nonzero, where TE0 is a TE0 mode, and where TE1 is TE1 mode.

18. The method of claim 14, wherein the combined modes and the orthogonal output modes are each elliptically polarized.

19. The method of claim 14, wherein the combined modes and the orthogonal output modes are each linearly polarized at least three degrees from parallel to a top surface of the polarization rotator and at least three degrees from perpendicular to the top surface of the polarization rotator.

20. The method of claim 14, wherein the first polarization is at least eighty-five and not more than ninety-five degrees from the second polarization.
